(19) United States
(12) Patent Application Publication
(10) Pub. No.: US 2020/0254606 A1
(43) Pub. Date: Aug. 13, 2020

(54) Form-able remote manipulation device

(71) Applicants: Nicholas Duane Morgan, Covington, VA (US); Homer Madison Warren, Covington, VA (US)

(72) Inventors: Nicholas Duane Morgan, Covington, VA (US); Homer Madison Warren, Covington, VA (US)

(73) Assignees: Nicholas Duane Morgan, Covington, VA (US); Homer Madison Warren, JR., Covington, VA (US)

(21) Appl. No.: 16/271,292

(22) Filed: Feb. 8, 2019

(51) Int. Cl. B25J 1/02

(52) U.S. Cl. CPC B25J 1/02

(57) ABSTRACT

A form-able remote manipulation device comprised of an elongated form-able sheath and grasping distal end used in conjunction with an air wedge as a method for unlocking an automobile without causing damage to said automobile. The method of using an air wedge in conjunction with a form-able remote manipulation device which is infinitely position-able allows the end user to efficiently unlock a modern automobile that current tools will not allow. The grasping portion of this device may be forced outward or inward in order to grapple or release an object that the user wants to manipulate in order to unlock said automobile. Rotation of the device will cause the object in which it is grappled with to become rotated along with the device if rotated. This remote manipulation device may also include, but not limit to, a wired or wireless camera attachment, wired or wireless light attachment, permanent magnet attachment, or electric-magnet attachment, that may be used in a non line of sight or an obscured view application.

### FIELD OF THE INVENTION

The present invention is directed to a method of unlocking an automobile by using an air wedge to gain access to the interior of an automobile along with a selectively form-able remote access gripping or manipulation tool that includes a claw portion, a actuation portion spaced apart from the gripping portion by a form-able sheath central portion that may be hollow, and may contain a cord or cable extending through the form-able member that connects the gripping portion and the actuation portion in order to unlock an automobile.

### BACKGROUND

### 1. Technical Field

The present disclosure relates generally to unlocking modern automobiles. Modern automobiles are increasingly more difficult for service providers to unlock with the current tools on the market due to present day security systems. Often times the services providers end up damaging the vehicle attempting to unlock the automobile due to the shortcomings of tools currently available on the market. In particular, the apparatus allows the end user to gain access of the interior of an automobile using an air wedge and remotely manipulating objects such as keys, buttons, switches, or handles inside of an automobile in order to unlock said automobile with the form-able remote manipulation device as disclosed.

### 2. Background of Related Art

Typically in an environment in which an individual is performing emergency automobile unlocking services the end goal is to unlock an automobile for a customer in the quickest manner possible without damaging said automobile. One type of available tool on the market is a simple bent steel bar that the service provider inserts into the door frame of the automobile which often causes significant amounts of paint and interior panel damage while trying to pop the door handle to unlock said automobile. In this method of unlocking an automobile it does not allow the service provider to grab keys or actuate buttons on the key fob as there is no gripping or grasping feature available on said tool, this type of method also will not allow a service provider to pull the door handles in the car due to modern security systems disabling the door handles from actuating in order to unlock said automobile once the automobile is locked by the door lock buttons or key fob buttons. Currently, the present tools available on the market make the end user apply pressure to the automobile body panels in order to actuate the door handle inside the automobile which routinely causes damage to the paint and interior panels, or with modern automobiles is simply not possible to unlock said automobile with current tools.

For example, many modern automobiles require that the end user grasp the keys or key fob in order to actuate the unlocking buttons and is not possible with current tools available on the marketplace. None are offered with a form-able sheath that holds the shape once formed by the user and has a grasping mechanism which grasps objects such as keys, purses, etc firmly without dropping them. An emergency auto unlocking service provider's efforts may result in frustration attempting to position the current tools available on the market using an antiquated method to manipulate the current tool in the proper location in order to unlock a modern automobile. These frustrations due to not having the proper tool in order to unlock modern automobiles order often results in hours of time wasted and often damage to said automobile.

### SUMMARY

The present disclosure relates to a method using an air wedge which is inserted into the door frame of an automobile in conjunction with a form-able remote manipulation device in order to unlock an automobile in an emergency situation. The air wedge allows the service provider to have room to insert the form-able remote manipulation device in the present disclosure into the automobile and grasp the keys, actuate buttons, or pull handles in order to unlock said automobile. The present disclosure includes a selectively form-able remote access gripping or manipulation tool that includes a claw portion, a actuation portion surrounded by a spring and spaced apart from the gripping portion by a form-able sheath central portion that is hollow, and contains a cord or cable extending through the form-able member that connects the gripping portion and the actuation portion. The present disclosure also includes removable or attachable accessories that may need to be used by the end user in conjunction with the form-able remote manipulation device for non-line of sight applications. This may also include, but not limit to, a wired or wireless camera attachment, wired or wireless light attachment, permanent magnet attachment, or electric-magnet attachment, that may be used in a non line of sight or an obscured view application.

Objects in the present method of this disclosure may be manipulated in a non line of sight application or where the object may or may not be visible and out of conventional reach such as in a purse, cup holder, ignition switch, seat, or floorboard of an automobile. This method of gaining access to the interior portion of the automobile by using an air wedge in conjunction with the form-able sheath device allows the user to position the device in an infinite amount of directions while holding the shape positioned by the user. This method will allow the user to extend their reach and manipulate objects while remotely accessing the interior of an automobile. One accessory this method may also include, a wired or wireless camera attachment, which may also include a wired or wireless light attachment. This camera device may be used in conjunction with any commercially available device that contains a mobile display so that the user can see and manipulate an object in a non line of sight application.

A drawback to current tools available on the market is that in conjunction with an air wedge they can not be formed in a given shape by the user in order to grasp or manipulate an object that may be inaccessible in an automobile when the end user is unlocking said automobile. Often times the end users must manipulate the keys or key fob in an automobile in order to unlock said automobile, but current tools on the market will not allow a user to remotely access keys or key fobs locked inside of an automobile due to not having a tool comprised of a form-able sheath and remote grasping end.

Another drawback to current tools such a traditional grabber disclosed by Winther S available on the market is that while flexible, they are not form-able and will not hold the shape positioned by the user. Note FIG. 8 in the drawings where the present invention is capable of lifting 8.6 pounds without deforming or straightening the form-able sheath from the shape that was formed by the user.

A method of transferring rotational motion in an articulating surgical instrument is disclosed in U.S. Pat. No. 8,142,473 B2 issued Mar. 27, 2012 to Cunningham J. According to this disclosure the tool and method for it to be used is for endoscopic surgical applications. A drawback to this method and design is that, while form-able to hold a given shape, it is not within the scope of the method nor the device to use this in unlocking an automobile as outlined in FIG. 2 as Cunningham specifically claims the method and device as a surgical endoscopic instrument. Sheer size constraints of a surgical device disallows it being an effective means of unlocking an automobile. Another drawback to this tool and method is it will not allow the end user to form the tool in order to grasp on to and rotate a key, for example, in the ignition switch of a car as it is not strong enough nor long enough nor will it grasp a set of keys as presently configured in the disclosure referenced in the present disclosure drawings FIG. 2. The present invention allows for the claimed method to be small enough in diameter to allow easy access into the interior portions of an automobile while the user being outside, operating the device on the interior portion of the automobile remotely while gaining access of the interior panels using our method of an air wedge used in FIG. 3.

There is, therefore, set forth according to the present invention a form-able remote manipulation device in conjunction with an air wedge in which the form-able sheath that it is comprised of holds the shape once formed by the end user which addresses the above objects, among others, and which overcomes the drawbacks of prior devices or methods of unlocking an automobile.

### BRIEF DESCRIPTION OF THE DRAWINGS

These and other features and advantages of the present disclosure will become better understood with reference to the brief description along with the detailed description of the accompanying drawings of the embodiments given below which serve to explain the principles of the disclosure.

FIG. 1 is a perspective view of an infinitely form-able remote manipulation device which has a distal gripping feature separated by an elongated form-able sheath in accordance with the present disclosure;

FIG. 2 is a perspective view of the manipulation device of FIG. 1 being inserted into the interior of an automobile via a commercially available air wedge while the user manipulates the keys out of the ignition switch of an automobile from the exterior of an automobile;

FIG. 3 is a perspective view of the manipulation device of FIG. 1 being inserted into the interior of an automobile via a commercially available air wedge while the user manipulates the modern automobile key fob in order to unlock said automobile from the exterior of the automobile;

FIG. 4 is a perspective view of the manipulation device of FIG. 1 being inserted into the interior of an automobile via a commercially available air wedge while the user manipulates the door panel locking pin mechanism with the grasping portion of the device in FIG. 1 in order to unlock said automobile from the exterior of the automobile;

FIG. 5 is a perspective view of the manipulation device of FIG. 1 being inserted into the interior of an automobile via a commercially available air wedge while the user manipulates buttons in the center console with the grasping portion of the device in FIG. 1 in order to unlock said automobile from the exterior of the automobile;

FIG. 6 is a perspective view of the manipulation device of FIG. 1 including a permanent magnet attachment;

FIG. 7 is a perspective view of the manipulation device of FIG. 1 including a electromagnet attachment;

FIG. 8 is a perspective view of the manipulation device of FIG. 1 lifting 8.6 pounds via a scale without deformation of the device that was formed into the given shape by the end user;

FIG. 9 is a perspective view of the manipulation device of FIG. 1 with the commercially available bore scope camera attachment with a modern mobile device being used as the display.

### DETAILED DESCRIPTION

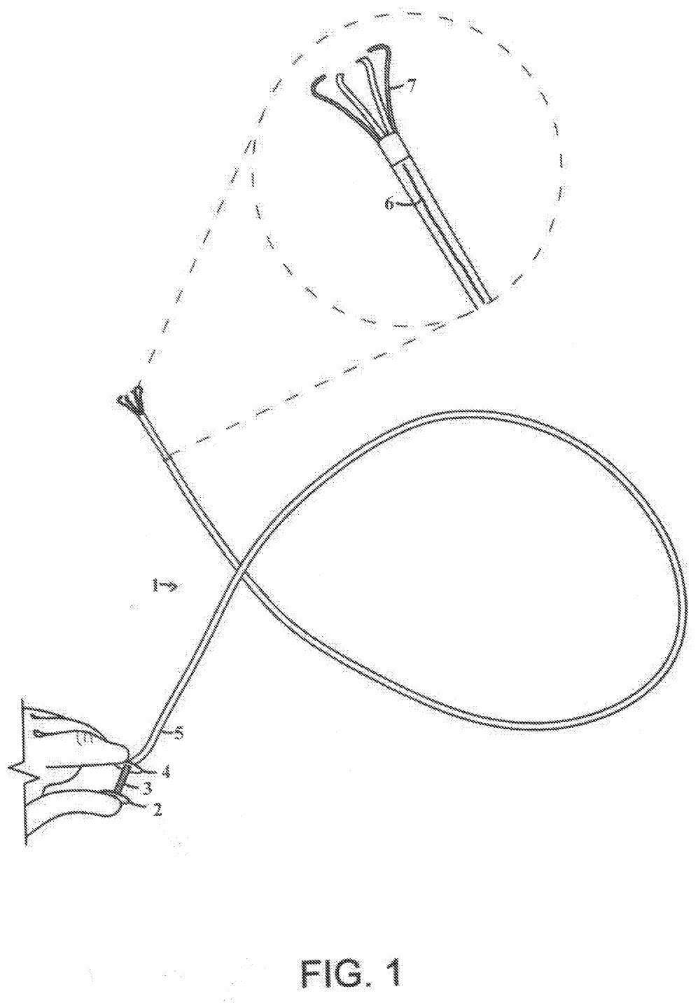

Referring initially to FIG. 1, an infinitely form-able remote manipulation device is depicted generally as 1. The instrument 1, includes a handle portion 4 near a proximal end actuator 2, a compression spring 3, an infinitely form-able sheath 5 that holds the position once positioned by the end user, a cable or string 6, which connects the distal end 2, and claw 7 and allows the user to actuate or apply force via the effector once positioned by the user.

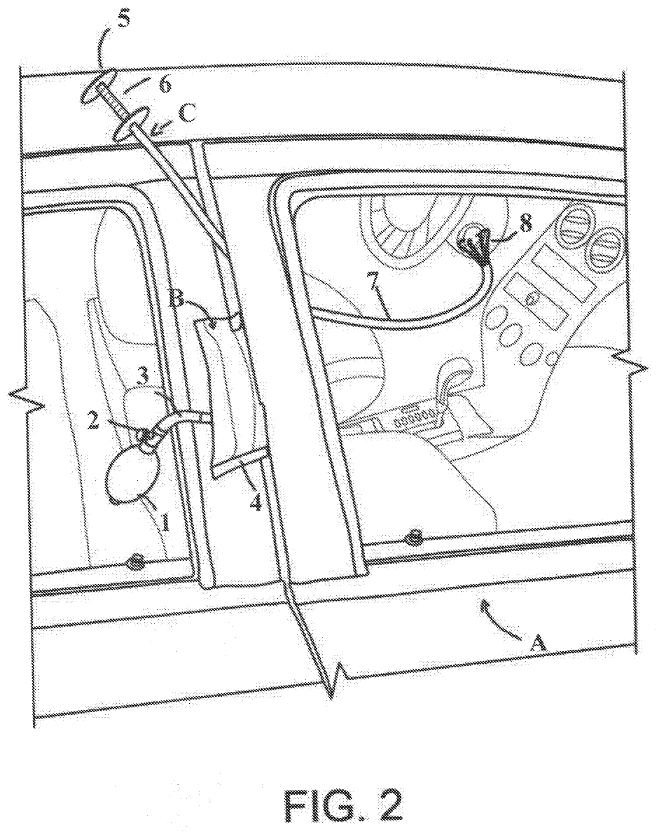

Referring to FIG. 2, the device from FIG. 1 is inserted into the interior of an automobile A via a commercially available air wedge B which is inserted between the door frame and main body of the automobile A. In regards to air wedge in B the components of said air wedge are 1, a bulb pump, 2, an air release valve, 3 a hose to transfer air from the bulb pump into the air wedge, and 4 the air wedge which applies force to the door frame and automobile to give access for the device as described in FIG. 1 into the automobile in order to unlock it. In regards to drawing FIG. 2, C is the device as described in full in FIG. 1 and has components of 5 which is the end actuator, 6 which is the coil spring, 7 which is the infinitely form-able sheath and 8 which is the gripping mechanism which allows the user to apply force and grab the keys out of the ignition switch in the automobile in this drawing.

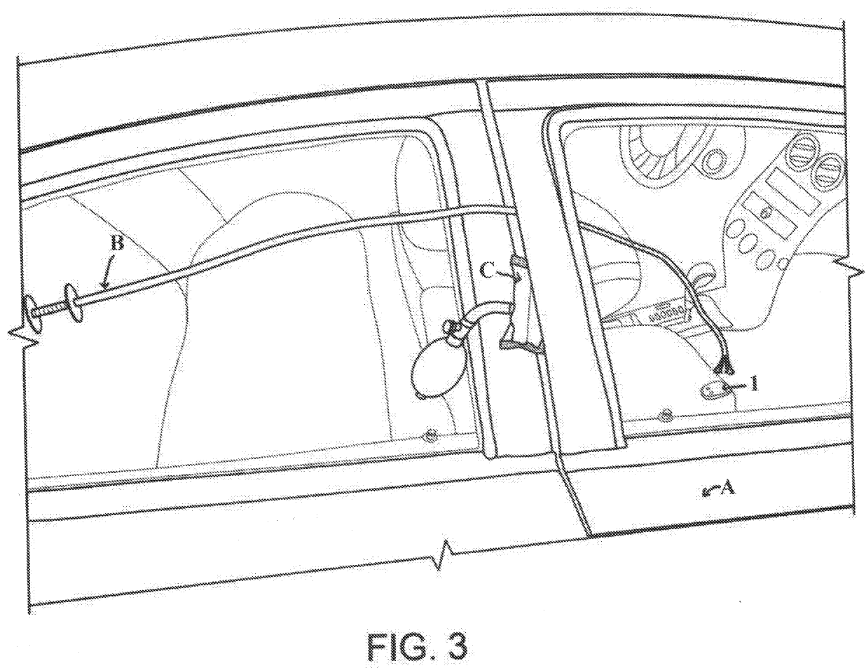

Referring to FIG. 3, the device B, in this illustration from FIG. 1 is inserted into the interior of an automobile A via a commercially available air wedge C as described in FIG. 2 in order to manipulate a modern automobile key fob 1 in order to unlock said automobile A as illustrated in FIG. 3.

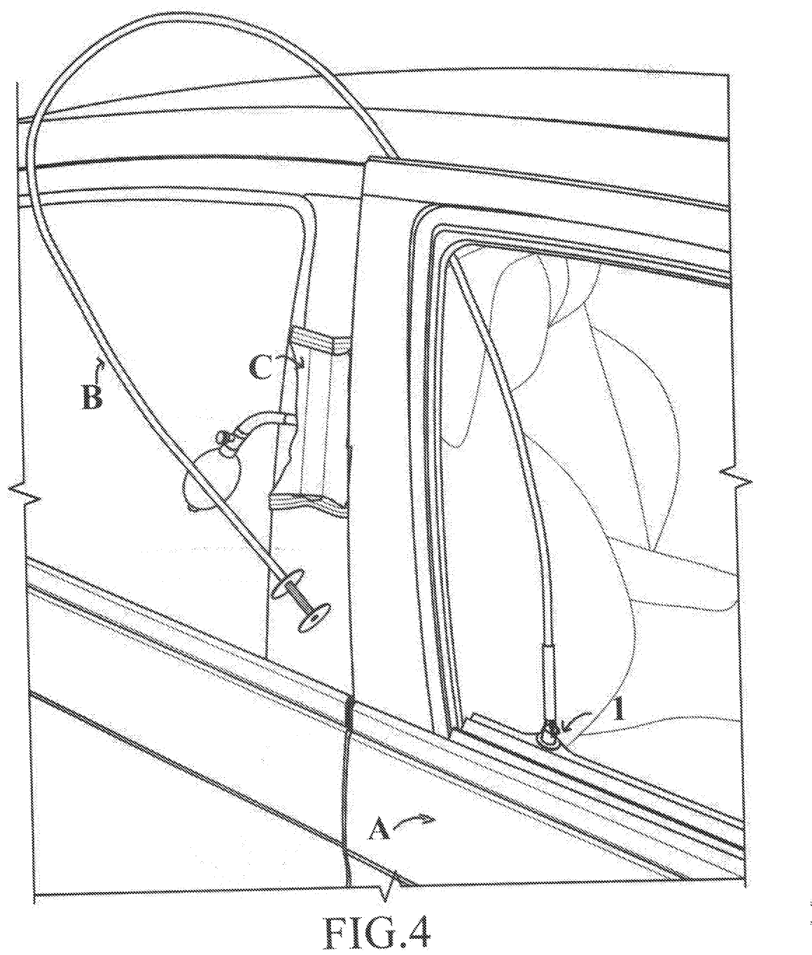

Referring to FIG. 4, the device B, in this illustration from FIG. 1 is inserted into the interior of the automobile A via a commercially available air wedge C as described in FIG. 2 in order to pull up and unlock the door panel pin mechanism referred to as 1 in this illustration.

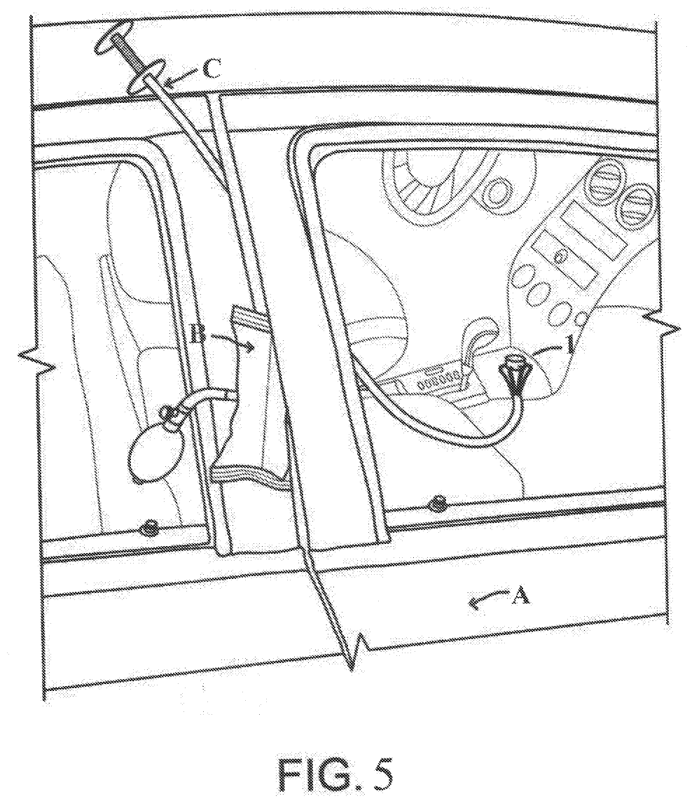

Referring to FIG. 5, the device C, in this illustration from FIG. 1 is inserted into the interior of the automobile A via a commercially available air wedge B as described in FIG. 2 in order to actuate buttons in the center console of automobile A in order to unlock said automobile.

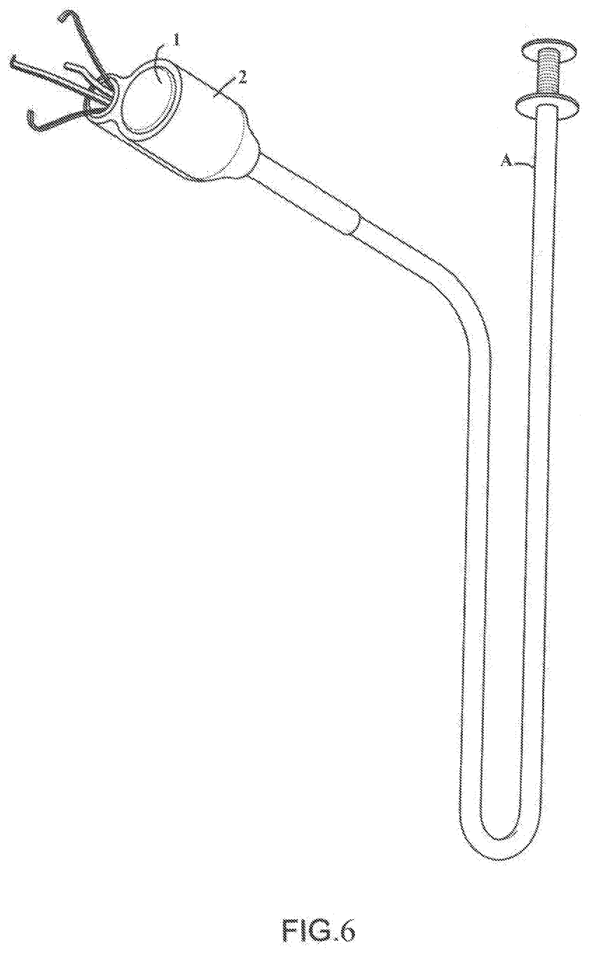

Referring to FIG. 6, the device as described in FIG. 1 is illustrated as A with a permanent NdFeB magnet 1 with attachment 2 which slides over or clips on the end of the device as described in FIG. 1.

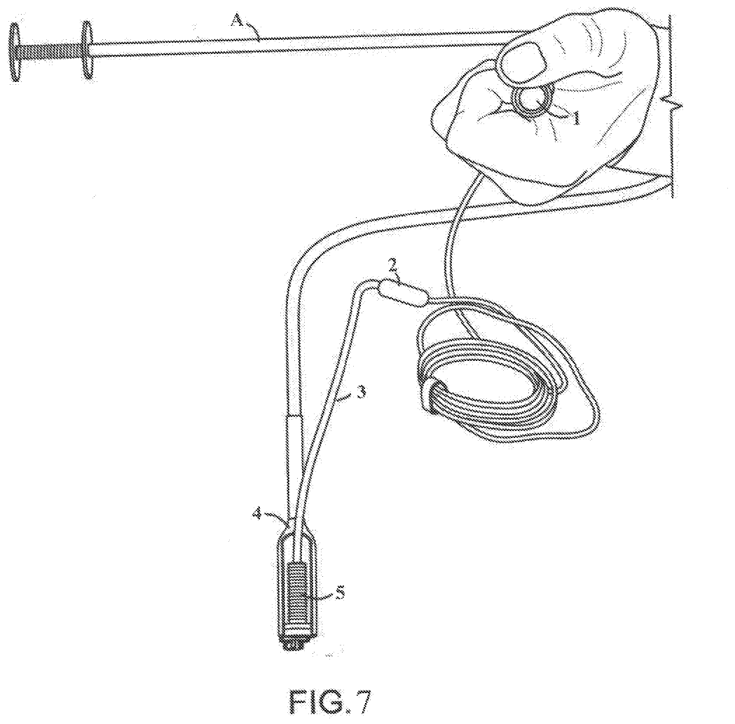

Referring to FIG. 7, the device A, in this illustration from FIG. 1 is illustrated with an electromagnet attachment. This attachment consists of a momentary switch 1, a dc power supply such as a commercially available battery 2, 3 a multiple conductor wire, 5 a wire wrapped iron core electromagnet and 4 the attachment which slides over or clips on the end of the device as described in FIG. 1.

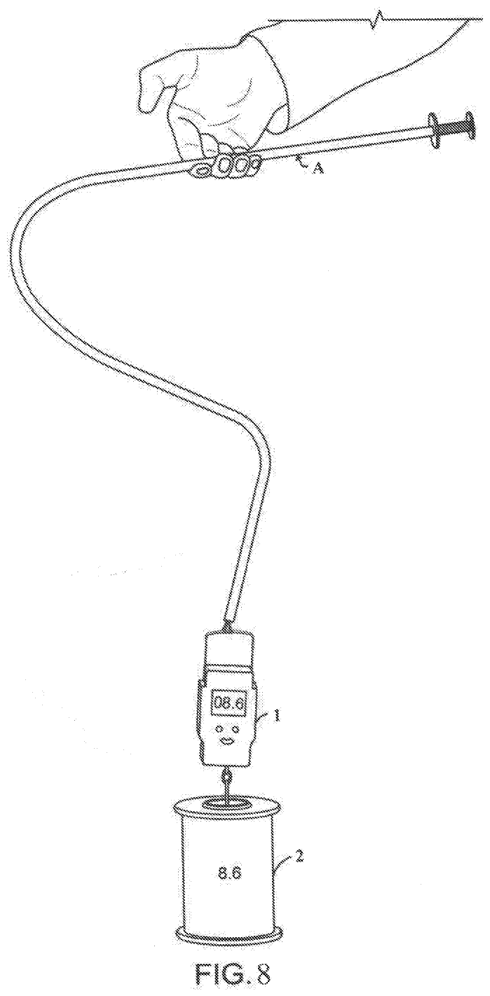

Referring to FIG. 8, the device A, in this illustration from FIG. 1 is illustrated showing the ability of the device to lift 8.6 pounds without deformation from the shape positioned by the end user. In this depiction 1 is a scale showing force and 2 is the 8.6 pound weight illustrating the sheath to deforming from the original shape that was defined by the user prior to lifting said weight.

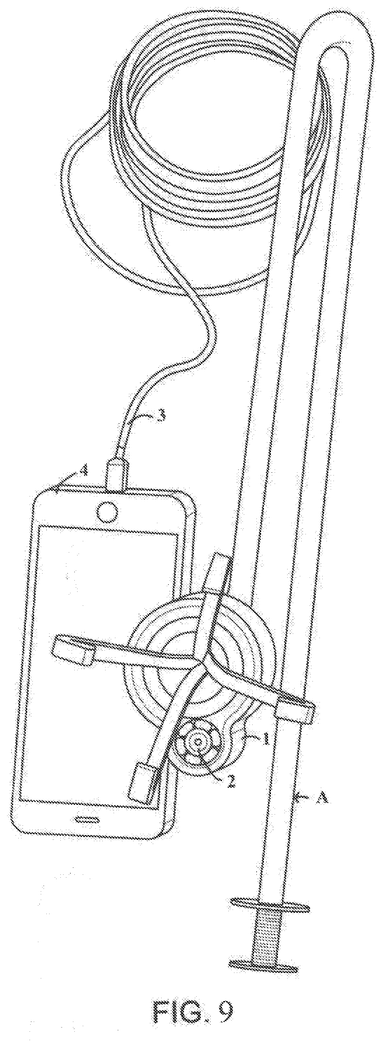

Referring to FIG. 9, the device A, in this illustration from FIG. 1 is illustrated showing the commercially available bore scope with light 2 attachment method 1 by clipping over the sheath as described in FIG. 1 used in conjunction with a wire 3, and modern commercially available mobile device 4. When the end effector is opened by the user in this configuration it allows the user to position the tool grasp an object while using their modern mobile device carried in their pocket to view objects in a non-line of sight application.

### PATENT CITATIONS: (31)

Publication number Priority date Publication date Assignee Title
U.S. Pat. No. 2,947,564A* 1957 Aug. 26 1960 Aug. 2 Simon P Winther Tool
U.S. Pat. No. 8,585,114B2 2012 Feb. 22 2013 Nov. 19 Kovarik Carter J, Kovarik Joseph E
US20030236549A1* 2000 Jul. 21 2003 Dec. 25 Frank Bonadio Surgical Instrument
U.S. Pat. No. 3,266,059A* 1963 Jun. 19 1966 Aug. 16 North American Aviation Inc Prestressed flexible joint for mechanical arms and the like
U.S. Pat. No. 3,576,343A 1968 Aug. 30 1971 Apr. 27 Gustaysbergs Fabriker Ab Gripping tongs
U.S. Pat. No. 3,527,492A 1968 Jun. 25 1970 Sep. 8 Jimmy L Davis Trash pick-up device
U.S. Pat. No. 3,346,293 A 1966 Mar. 11 1967 Oct. 10 Luman L Wilcox Clamp positioning device
U.S. Pat. No. 3,761,121A 1971 Jul. 13 1973 Sep. 25 A Reid Gripping tool with rotatable head
U.S. Pat. No. 4,039,216A 1974 Dec. 9 1977 Aug. 2 Imre Soos Manual grasping device
U.S. Pat. No. 4,253,697A* 1979 Jan. 8 1981 Mar. 3 Adam Acosta Remote retriever with interchangeable head
U.S. Pat. No. 4,393,728A* 1979 Mar. 16 1983 Jul. 19 Robotgruppen Hb Flexible arm, particularly a robot arm
U.S. Pat. No. 5,577,785A 1995 Sep. 11 1996 Nov. 26 Arcoa Industries Single-hand actuated pick-up tool
U.S. Pat. No. 5,647,622A* 1995 Feb. 27 1997 Jul. 15 Schectman; Leonard A. Flexible reach tool
U.S. Pat. No. 5,766,196A* 1994 Jun. 6 1998 Jun. 16 Tnco, Inc. Surgical instrument with steerable distal end
U.S. Pat. No. 5,895,082A 1996 Aug. 12 1999 Apr. 20 Kaluzny; William Manual pick up device
US20030236549A1* 2000 Jul. 21 2003 Dec. 25 Frank Bonadio Surgical instrument
US20050057055A1 2003 Sep. 17 2005 Mar. 17 Darlene Deal Tool for picking up clothes off the floor
U.S. Pat. No. 8,091,936B1 2010 Feb. 10 2012 Jan. 10 Graziano Michael V Gripping device
U.S. Pat. No. 7,980,609B2 2007 Jan. 30 2011 Jul. 19 Ontel Products Corporation Remote pick-up devices
US79347 6B2* 2008 Jun. 11 2011 May 3 Kroeze Designs, Llc Adjustable gripping device
U.S. Pat. No. 8,142,473B2* 2008 Oct. 3 2012 Mar. 27 Cunningham, J Method of transferring rotational motion in an articulating surgical instrument
US20120265175-A1* 2011 Apr. 14 2012 Oct. 18 Deflandre, Nicolas Malleable instrument for laparoscopic procedures
US20170150020-A1* 2015 Nov. 25 2019 Jul. 23 Edwards, C Illuminated object viewing and retrieving tool
US201300 9810-A* 2011 Sep. 28 2017 May 20 Isenberg, John Surgical Devices and Mechanisms
US3481641-A* 1967 Jun. 23 1969 Dec. 2 Berger, D Grasping Implement
U.S. Pat. No. 4,945,920-A* 1988 Mar. 28 1990 Aug. 7 Clossick, J Torqueable and formable biopsy forceps
U.S. Pat. No. 4,253,697-A* 1979 Jan. 8 1981 Mar. 3 Acosta, A Remote retriever with interchangeable head
U.S. Pat. No. 5,746,462-A* 1996 Dec. 12 1998 May 5 Lee, C. H. Flexible vacuum pick-up device
U.S. Pat. No. 1,519,938-A* 1923 Sep. 13 1924 Dec. 16 Smith, D Flexible Pliers
U.S. Pat. No. 6,139,563-A* 1997 Sep. 25 2000 Oct. 31 Cosgrove, III; Delos M. Surgical device with malleable shaft
U.S. Pat. No. 9,833,894-B2* 2014 May 23 2017 Dec. 5 Cosgrove, III; Delos M. Surgical device with malleable shaft

We claim:

1. A remote manipulation device extending the reach of a person, the device comprising:
a form-able sheath that may be composed of conductive or non-conductive materials which is form-able in an infinite amount of ways that holds the shape it is positioned in by the user.

2. This form-able sheath device allows the user to position the device in an infinite amount of directions while holding the shape positioned by the user. This will allow the user to extend their reach and manipulate objects that may be obscured in view which may include, but not limit it to, remotely accessing the interior of an automobile which may also include unlocking said automobile. Other tools on the market will not allow a user to form the device into a given shape, reach into the interior portions of an automobile, and manipulate objects that may be locked inside of said automobile.

3. This device may also be configured in a manner in which it allows the end user to grasp or manipulate an object from the inside diameter of said object, which for example may be a tube.

4. This invention may also include, but not limit to, a wired or wireless camera attachment, wired or wireless light attachment, permanent magnet attachment, electric-magnet attachment, that may be used in a non line of sight or an obscured view application.
